(19) United States
(12) Patent Application Publication
(10) Pub. No.: US 2026/0036174 A1
(43) Pub. Date: Feb. 5, 2026

(54) Sensor Bearing Assembly and Associated Sensing Support and Pulley Unit

(71) Applicant: Aktiebolaget SKF, Goteborg (SE)

(72) Inventors: Vincent SAUSSET, Azay-le-Rideau (FR); Sylvain CHAUSSAT, Mont-Pres-Chambord (FR)

(21) Appl. No.: 19/280,790

(22) Filed: Jul. 25, 2025

(30) Foreign Application Priority Data
Aug. 1, 2024 (DE) 102024207315.6

(51) Int. Cl. F16C 41/00; B66D 1/28

(52) U.S. Cl. CPC F16C 41/007; B66D 1/28; B66D 2700/026

(57) ABSTRACT

A sensor bearing assembly and associated sensing support and pulley unit. The sensor bearing assembly includes a sensor body (11) and a bearing (12). The bearing includes an inner ring and an outer ring centred on an axis (X-X′). An impulse ring (14) is secured to the outer ring. The sensor bearing assembly can also include a sensor device (16) for detecting rotational parameters of the impulse ring. The sensor device includes at least one sensor element (17) supported by the sensor body (11) and cooperating with the impulse ring. The sensor body (11) has an inner through-hole (26) having a non-circular shaped section (28).

### CROSS-REFERENCE TO RELATED APPLICATION

This application claims priority to German Patent Application No. 102024207315.6, filed Aug. 1, 2024, the entirety of which is hereby incorporated by reference.

### FIELD

The present disclosure relates to a sensor bearing assembly comprising a bearing, an impulse ring, a sensor device and a sensor body supporting the sensor device.

The present disclosure also relates to a sensing support and a pulley unit associated to such a sensor bearing assembly.

The present disclosure relates to a sensor bearing assembly notably adapted for lifting systems, for example used for autonomous forklifts.

### BACKGROUND

Autonomous forklifts are generally used to transport loads by lifting them with a fork. The fork is driven by a motor, a pulley system and a flexible drive that transmits the power of the motor to the pulley.

In general, autonomous forklifts measure the height of the fork in relation to the ground with the aid of at least one telemeter which is separately mounted on a stationary part of the forklift.

The installation of such a telemeter is delicate as great care must be taken to ensure accurate positioning for a reliable measurement. Furthermore, the measurement precision may vary depending on the ambient operating conditions (such as bright light, dust particles, etc.) and the measurement reliability may be prone to error if the telemeter beam does not reflect well.

Moreover, such a configuration does not allow a compact measuring apparatus and the telemeter may be subject to accidental impacts.

One aim of the present disclosure is to overcome these drawbacks.

### SUMMARY

The present disclosure relates to a sensor bearing assembly comprising a sensor body, a bearing comprising an inner ring and an outer ring centred on an axis, the inner ring being secured onto the sensor body, an impulse ring secured to the outer ring of the bearing, and a sensor device for detecting rotational parameters of the impulse ring comprising at least one sensor element supported by the sensor body and cooperating with the impulse ring.

The sensor body is provided with an inner through-hole having a non-circular shaped section.

Such a sensor bearing assembly optimizes compactness and allows an increased integration. The shape of the sensor body allows obtaining an integrated anti-rotation means.

For example, the sensor body comprises a central ring delimiting an axial length of the sensor body, and a base protruding radially from the central ring, the inner ring of the bearing abutting axially against the base.

Advantageously, the base and the central ring form a plane lateral face of the sensor body. Such a design helps optimizing compactness.

Preferably, the inner through-hole of the sensor body comprises two opposite parallel flat surfaces. Such opposite parallel flat surfaces represent anti-rotation means for blocking the rotation of the sensor body with respect to a support.

For example, the impulse ring comprises a radial portion and an axial portion, the radial portion being secured to the outer ring of the bearing and protruding radially inwards with respect to the outer ring, the axial portion protruding axially in a chamber provided on the base of the sensor body. Such a design helps optimizing compactness.

Preferably, the axial portion is provided with a plurality of detection targets.

In one embodiment, the detection targets of the plurality of detection targets are equally spaced over a circumference of the axial portion.

Advantageously, the sensor device is provided with a cable extending radially outwards in respect to the base and at a predetermined angle. Such a configuration reduces the risk of accidental impact on the cable.

According to another aspect, the present disclosure relates to a sensing support comprising a support with two opposite-facing arms and a sensor bearing assembly as specified above. The sensor bearing assembly is mounted on the support with a pin inserted in the inner through-hole of the sensor body and in two opposite holes provided on each of the arms. The pin has a transverse section that matches respectively the section of the inner through-hole of the sensor body and the section of each of the two opposite holes, so as to block any relative rotation between the sensor bearing assembly and the support.

According to another aspect, the present disclosure relates to a pulley unit comprising a sensing support as specified above, a pulley mounted on the outer ring of the bearing of the sensor bearing assembly and a flexible drive mounted on the pulley.

### BRIEF DESCRIPTION OF THE DRAWINGS

The present disclosure and its advantages will be better understood by studying the detailed description of a specific embodiment given by way of non-limiting example and illustrated by the appended drawings on which:

FIG. 1 is a perspective view of a sensor bearing assembly according to an example of the present disclosure;

FIG. 2 is a cross-section along axis II-II of FIG. 1;

FIG. 3 is a perspective view of a pulley unit comprising the sensor bearing assembly of FIG. 1 according to an example of the present disclosure; and

FIG. 4 is an exploded view of the pulley unit of FIG. 3.

### DETAILED DESCRIPTION

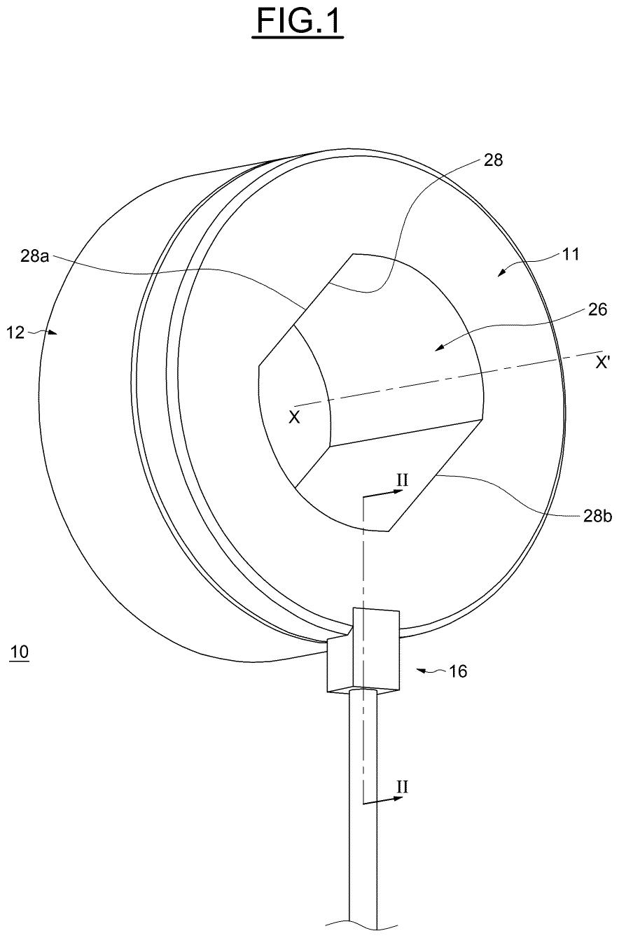

The sensor bearing assembly 10 represented on FIG. 1 is particularly adapted to equip an autonomous forklift.

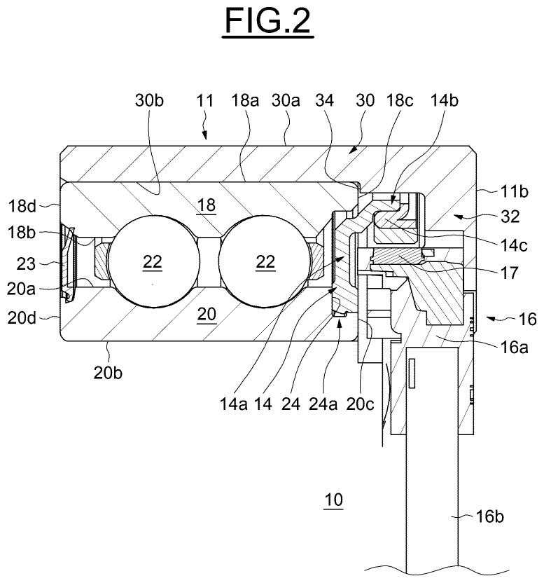

As shown on FIGS. 1 and 2, the sensor bearing assembly 10 comprises a sensor body 11, a bearing 12, and an impulse ring 14 (visible on FIG. 2) and a sensor device 16 supported by the sensor body 11. The bearing 12 and the impulse ring 14 form a sensor bearing unit. The sensor device 16 detects rotational parameters of the impulse ring 14 and comprises at least one sensor element 17 supported by the sensor body 11 and cooperating with the impulse ring 14.

The bearing 12 comprises an inner ring 18 and an outer ring 20. The inner and outer rings 18, 20 are concentric and extend axially along the bearing rotation axis X-X′ which runs in an axial direction. The outer ring 20 radially surrounds the inner ring 18. The inner and outer rings 18, 20 are made of steel.

The impulse ring 14 is secured to the outer ring 20 of the bearing 12 and the sensor device 16 is secured to the sensor body 11.

In the illustrated example, the bearing 12 also comprises two rows of rolling elements 22, which are provided here in the form of balls, interposed between raceways (not referenced) formed on the inner and outer rings 18, 20.

The bearing 12 also comprises a cage (not referenced) for maintaining the regular circumferential spacing of the rolling elements 22. The bearing 12 further comprises a seal 23 radially disposed between the inner and outer rings 18, 20 to define a closed space inside which the rolling elements 22 are arranged.

The outer ring 20 is provided with a cylindrical inner surface or bore 20a and with an outer cylindrical surface 20b which is radially opposite to the bore 20a. In the illustrated example, toroidal circular raceways for the rolling elements 22 are formed from the bore 20a, said raceways being directed radially inwards. A groove (not referenced) is also formed on the bore 20a into which is secured the seal 23.

In this example, the outer ring 20 is also provided with two opposite radial lateral faces 20c, 20d which axially delimit the outer surface 20b of said ring.

The outer ring 20 is provided with a recess 24 that extends axially inwards from the lateral face 20c. The recess 24 and the lateral face 20d delimit the bore 20a of said ring. The recess 24 is provided with a groove 24a.

Similarly to the outer ring 20, the inner ring 18 is provided with a cylindrical inner surface or bore 18a and with an outer cylindrical surface 18b which is radially opposite to the bore 18a. In the illustrated example, toroidal circular raceways for the rolling elements 22 are formed from the outer surface 18b, said raceway being directed radially outwards.

The inner ring 18 is also provided with two opposite radial lateral faces 18c, 18d which axially delimit the bore 18a and the outer surface 18b of said ring.

As notably shown on FIG. 1, the sensor body 11 is provided with an inner through-hole 26 having a non-circular shaped section 28. The through-hole 26 comprises two opposite parallel flat surfaces 28a, 28b and two opposite concave surfaces 28c, 28d connected to the flat surfaces 28a, 28b.

The sensor body 11 comprises a central ring 30 and a base 32. The base 32 and the central ring 30 form a plane lateral face 11b of the sensor body 11.

The central ring 30 extends axially and delimits the axial length of the sensor body 11. The central ring 30 is provided with an inner surface or bore 30a and with an outer cylindrical surface 30b which is radially opposite to the bore 30a. The bore 30a forms the through-hole 26 of the sensor body 11.

The base 32 protrudes radially from the central ring 30 forming a shoulder 34.

The inner ring 18 is secured onto the sensor body 11. Preferably, the bore 18a is secured to the outer cylindrical surface 30b and the lateral face 18c axially abuts against the shoulder 34.

As previously mentioned, in the disclosed example, the impulse ring 14 is secured to the outer ring 20. The impulse ring 14 comprises a radial portion 14a and an axial portion 14b. The radial portion 14a is secured to the outer ring 20, for example by press-fitting to the recess 24 and the groove 24a. The radial portion 14a protrudes radially inwards with respect to the outer ring 20. The axial portion 14b protrudes axially in a chamber 36 provided on the base 32 of the sensor body 11.

The axial portion 14b of the impulse ring 14 is provided with a plurality of detection targets 14c radially facing the sensor elements 17. Preferably, the detection targets 14c of the plurality of detection targets 14c are equally spaced over a circumference of the axial portion 14b.

The impulse ring 14 and the sensor elements 17 may use any suitable technology, such as induction technology, optic technology or magnetic technology. In case of magnetic technology, the impulse ring 14 may include alternating North and South poles and the sensor elements 17 may include Hall-effect sensors.

Preferably, the sensor device 16 comprises a sensor housing 16a that supports and protects the sensor elements 17. The sensor device 16 further comprises a cable 16b supported by the sensor housing 16a and comprising electrical wires (not shown). The cable 16b extends radially outwards in respect to the base 32 and at a predetermined angle.

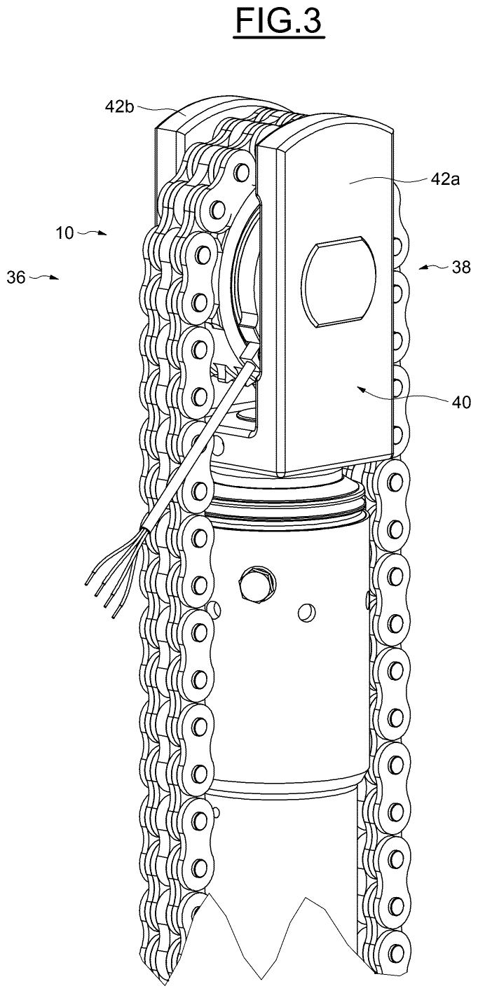

As shown on FIG. 3, the sensor bearing assembly 10 is particularly adapted for use in a pulley unit 36 and more generally in a sensing support 38.

Here, the sensing support 38 comprises a support 40 with two opposite-facing arms 42a, 42b and a sensor bearing assembly 10 as previously described.

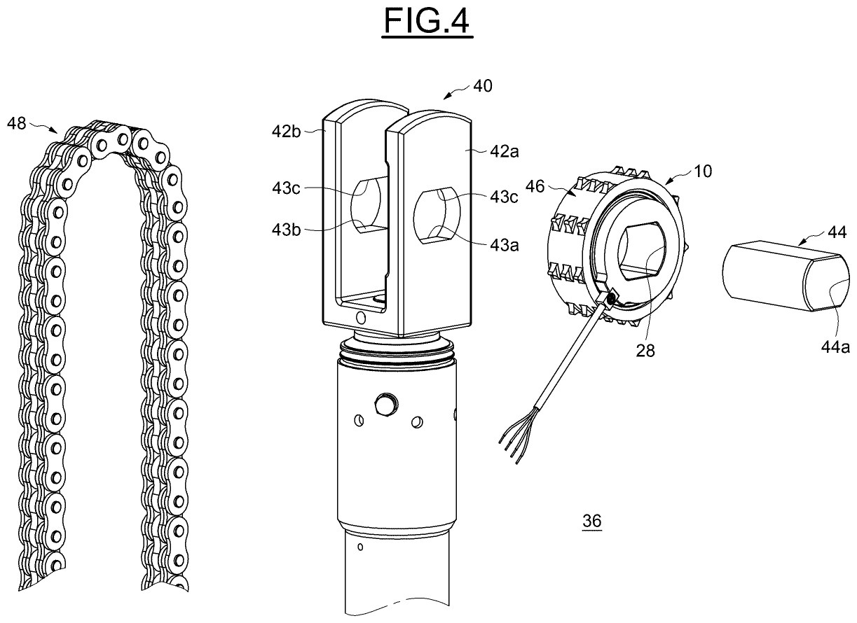

The sensor bearing assembly 10 is mounted on the support 40 with a pin 44 inserted in the through-hole 26 of the sensor body 11 and in two opposite holes 43a, 43b provided on each of the arms 42a, 42b (FIG. 4). The section 43c of each of the two holes 43a, 43b is the same as the section 28 of the through-hole 26 of the sensor body 11.

The pin 44 has a transverse section 44a that matches respectively the section 28 of the through-hole of the sensor body 11 and the section 43c of each of the two holes 43a, 43b, so as to block any relative rotation between the sensor bearing assembly 10 and the support 40.

In the illustrated example, the pulley unit 36 comprises the sensing support 38, a pulley 46 and a flexible drive 48. Here, the pulley 46 is a sprocket wheel mounted on the outer ring 20 of the bearing 12 of the sensor bearing assembly 10. The pulley 46 is driven by a flexible drive 48 mounted on the pulley 46. Here, the flexible drive 48 is a chain drive. Alternatively, the flexible drive 48 may be a belt, a rope or a cable.

In the illustrated examples, the sensor bearing assembly is provided with a rolling bearing comprising two rows of rolling elements. Alternatively, the rolling bearing may comprise a different number of rows, for example one or at least three rows of rolling elements. In the illustrated examples, the rolling elements are balls. Alternatively, the rolling bearing may comprise other types of rolling elements, for example rollers. In another variant, the rolling bearing may also be provided with a sliding bearing having no rolling elements.

What is claimed is:

1. A sensor bearing assembly comprising:
a sensor body having an inner through-hole with a non-circular shaped section;
a bearing comprising an inner ring and an outer ring centred on an axis, the inner ring being secured onto the sensor body;
an impulse ring secured to the outer ring of the bearing; and
a sensor device for detecting rotational parameters of the impulse ring, the sensor device comprising at least one sensor element supported by the sensor body, the at least one sensor cooperating with the impulse ring.

2. The sensor bearing assembly according to claim 1, wherein the sensor body comprises a central ring delimiting an axial length of the sensor body and a base protruding radially from the central ring, the inner ring of the bearing abutting axially against the base of the sensor body.

3. The sensor bearing assembly according to claim 2, wherein the base and the central ring form a plane lateral face of the sensor body.

4. The sensor bearing assembly according to claim 1, wherein the inner through-hole of the sensor body comprises two opposite parallel flat surfaces.

5. The sensor bearing assembly according to claim 1, wherein the impulse ring comprises a radial portion and an axial portion, the radial portion being secured to the outer ring of the bearing and protruding radially inwards with respect to the outer ring, the axial portion protruding axially in a chamber provided on the base of the sensor body.

6. The sensor bearing assembly according to claim 5, wherein the axial portion is provided with a plurality of detection targets.

7. The sensor bearing assembly according to claim 6, wherein the detection targets of the plurality of detection targets are equally spaced over a circumference of the axial portion.

8. The sensor bearing assembly according to claim 1, wherein the sensor device includes a cable extending radially outwards in respect to the base and at a predetermined angle.

9. A sensing support comprising:
a support with two opposite-facing arms;
a pin; and
the sensor bearing assembly according to claim 1;
wherein the sensor bearing assembly is mounted on the support with the pin inserted in the inner through-hole of the sensor body and in two opposite holes provided on each of the arms, the pin having a transverse section that matches respectively the section of the inner through-hole of the sensor body and the section of each of the two opposite holes so as to block any relative rotation between the sensor bearing assembly and the support.

10. A pulley unit comprising:
the sensing support according to claim 9;
a pulley mounted on the outer ring of the bearing of the sensor bearing assembly; and
a flexible drive mounted on the pulley.

11. The sensor bearing assembly according to claim 3, wherein the inner through-hole of the sensor body comprises two opposite parallel flat surfaces.

12. The sensor bearing assembly according to claim 11, wherein the impulse ring comprises a radial portion and an axial portion, the radial portion being secured to the outer ring of the bearing and protruding radially inwards with respect to the outer ring, the axial portion protruding axially in a chamber provided on the base of the sensor body.

13. The sensor bearing assembly according to claim 12, wherein the axial portion is provided with a plurality of detection targets.

14. The sensor bearing assembly according to claim 13, wherein the detection targets of the plurality of detection targets are equally spaced over a circumference of the axial portion.

15. The sensor bearing assembly according to claim 14, wherein the sensor device includes a cable extending radially outwards in respect to the base and at a predetermined angle.

16. A sensing support comprising:
a support with two opposite-facing arms;
a pin; and
the sensor bearing assembly according to claim 15;
wherein the sensor bearing assembly is mounted on the support with the pin inserted in the inner through-hole of the sensor body and in two opposite holes provided on each of the arms, the pin having a transverse section that matches respectively the section of the inner through-hole of the sensor body and the section of each of the two opposite holes so as to block any relative rotation between the sensor bearing assembly and the support.

17. A pulley unit comprising:
the sensing support according to claim 16;
a pulley mounted on the outer ring of the bearing of the sensor bearing assembly; and
a flexible drive mounted on the pulley.
